(19) United States
(12) Patent Application Publication
(10) Pub. No.: US 2009/0228360 A1
(43) Pub. Date: Sep. 10, 2009

(54) EMAIL ADVERTISEMENT SYSTEM AND METHOD FOR ONLINE RETAIL

(75) Inventors: Robert Mancarella, Portsmouth, NH (US); Rick Blaisdell, Stratham, NH (US)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: MAILMETHODS, LLC, Stratham, NH (US)

(21) Appl. No.: 12/397,376

(22) Filed: Mar. 4, 2009

Related U.S. Application Data
(60) Provisional application No. 61/034,578, filed on Mar. 7, 2008.

(51) Int. Cl. G06Q 30/00; G06F 15/16

(52) U.S. Cl. 705/14; 705/26; 709/204

(57) ABSTRACT

An outgoing email server inserts electronic advertisements into outgoing order confirmations and order cancellation notices generated by an online retail system. The server creates an enhanced email order notification in which the text of the email is framed with one or more electronic advertisements, as well as banners or footers related to the company or organization hosting the online retail system. The system searches for product identification codes, such as SKU numbers, for each product purchased by the customer at the online store in the case of an order confirmation notice, or for each product for which an order has been canceled in the case of an email order cancellation notice. In the case of order confirmations, the system statistically correlates the frequency that various products have been sold contemporaneously in the same shopping cart by past customers, and places advertisements in the outgoing order confirmation based on that statistical analysis. In the case of order cancellation notices, the system searches for the canceled product identification code or SKU number and places advertisements relating to suggested replacement products.

### CROSS-REFERENCE TO RELATED APPLICATION

This application is based on and claims priority from U.S. Provisional Patent Application Ser. No. 61/034,578 filed on Mar. 7, 2008.

### FIELD OF THE INVENTION

The invention relates primarily to online shopping systems, and in particular the placement of electronic advertisements in outgoing email order notifications such as order confirmations or order cancellation notices.

### BACKGROUND OF THE INVENTION

Online shopping over the internet is becoming more popular. Typically, a potential customer will visit a retailer's website and enter the retailer's online e-commerce store. Online stores normally contain an image of each of the goods being sold along with a description of the product and a price. In addition, many online stores allow the customer to view an enlarged image of the product and/or additional information regarding the product. Most online stores use shopping cart software with a checkout process for inputting and confirming billing or credit card information. Once the customer has checked out, the customer is emailed a receipt and/or an order confirmation notice. Digital products such as music or software are delivered to the customer normally via a software download over the internet. On the other hand, physical goods, such as clothing, etc. are normally shipped to the customer's address. In these cases, it is typical for the online retail system to automatically generate outgoing email messages and send the messages to the customer at various stages of the process. For example, outgoing email order confirmations are sent initially to confirm that an order has been accepted, and then another confirmation may be sent when the order is shipped. Sometimes, an ordered product may not in fact be in inventory, which will result in an order cancellation notice. Such cancellations can be frustrating for the customer and also to the retailer.

Virtually all retailers use stock keeping units (SKU numbers) as a unique identification code for each of the distinct products and services that can be ordered from the retailer. SKU numbers are generally a combination of alpha numeric characters that enable retailers to systematically track its inventory. A distinct SKU number is attached to each product and all its variants, for example, a blue shirt would normally have a different SKU number than the same shirt in the color red. Also, different SKU numbers may be used to identify different warehouse locations for the same product. Also, different SKU numbers are sometimes assigned to the same product to track price changes. Further, SKU numbers are often assigned to all billable entities, e.g. warranties, delivery fees, installation fees, etc.

While SKU numbers are widely utilized, other identification codes are used throughout industry, for example, part numbers, universal product codes, etc.

### SUMMARY OF THE INVENTION

The invention relates to email advertising systems and methods that create enhanced email messages by supplementing original outgoing email messages generated by an online retail system with one or more electronic advertisements. An outgoing email server, such as an SMTP server, contains software for programming the electronic advertising campaign. For example, in the preferred embodiment, the outgoing email server contains software for importing electronic advertisement images for each of the products sold through the online retail system, software for detecting SKU numbers or other unique identification codes for the products referred to in an outgoing email order notification, software for preferentially selecting electronic advertisements to be placed in the enhanced outgoing email order notification depending on the detected SKU number or product identification code, and software for creating the enhanced outgoing email message supplemented with the selected electronic advertisements, as well as software for implementing other functions described herein.

In one aspect, the invention is a method of, and a system for, selecting electronic advertisements for insertion into outgoing email order confirmations automatically generated by an online retail system upon customer checkout. The online retail system sells a group of products with each product being assigned a unique identification code, such as a SKU number. Email order confirmation notices generated by online retail system and sent to the customer includes the unique identification code or SKU number for each product ordered by customer in the respective shopping cart. The outgoing email order confirmation is received by an outgoing email advertisement server. The electronic advertisements for the group of products sold on the online retail store are stored on the outgoing email server, and the electronic advertisement for each product is assigned the unique identification code (e.g., SKU number) for that product. One or more identification codes (e.g. SKU numbers) for other products sold through the online retail store are linked to the identification code (e.g., SKU numbers) for each of the products sold through the online retail store in the group. Preferably, this linking is done via statistical correlation, and more specifically, via an analysis of past outgoing email order confirmations that have been sent through the system.

The system preferably maps each of the SKU numbers which are contemporaneously present in each email order confirmation to determine which products customers are more likely to purchase together at the time of checkout given that the customer has already purchased certain products. The system statistically relates products to one another and places electronic advertisements in the outgoing email order confirmation based on this statistical correlation.

The server searches the content of the email order confirmation prepared and sent by the online retail system for the assigned identification code (e.g., SKU number) for each product purchased by the customer at the time of checkout. Then the system selects one or more of the stored electronic advertisements on the server based on the statistical correlation to the products that have actually been sold to the customer. Preferably, the system will not place an electronic advertisement for a product having an identification code or SKU number that appears in the outgoing email order confirmation. Also preferably, it will not place an advertisement if the system has been notified that the product is no longer in inventory. The outgoing email server then creates the enhanced outgoing email order confirmation in which the original content of the email order confirmation is supplemented with the selected one or more electronic advertisements, and sends the enhanced order confirmation to the customer.

When the customer selects or “clicks on” one of the placed electronic advertisements, the customer is directed to a destination URL associated with the selected advertisement which would typically be an organization's online store or the specific webpage in the store corresponding to the advertised product. The server tracks not only the placement of electronic advertisements in the outgoing enhanced email order confirmations but also customer selection of the placed advertisements. Moreover, the server tracks whether a selected electronic advertisement results in the sale of additional product from the online retail store. This may be accomplished, for example, by monitoring whether a subsequent email order confirmation is sent to the particular customer within a predefined time period.

In another aspect of the invention, if the outgoing email notification generated by the online retail store is an order cancellation, the system operates similarly except that the placed advertisements are for suggested replacement products. These suggestions would normally be determined by the organization and not typically via statistical analysis.

In another aspect of the invention, the system facilitates the automatic importing or uploading of electronic advertisement images from an online retail system to the outgoing email server. In particular, the preferred server reads an import file which includes the identification code (e.g., SKU number) for all products in the group as well as the destination URL for an electronic advertisement for each product and an image location URL for the advertisement image for each product. The import file preferably contains this information as comma-separated values, and would typically be supplied by the online retailer. The destination URL for the electronic advertisement is the destination that the end customer will be redirected to in the event that the advertisement is selected or clicked on by the customer when the customer receives the enhanced email notification. When directed to do so, the server automatically uploads each electronic advertisement image from its image location URL to the outgoing email server. Then, in order that the electronic image is appropriately sized, the system automatically scales the size of each uploaded electronic image to a size that is desirable for placement in the enhanced outgoing email order confirmation order cancellation notice. The preferred system also allows for automatic cropping of the uploaded electronic image before scaling in order to remove unwanted portions of the image, such as white space. The cropped and scaled electronic advertisement images are then stored on the outgoing email server.

Those skilled in the art should be able to appreciate that customers are more likely to pay attention to email order notifications than many other types of email advertising. The invention provides online retailers with the ability to conveniently select highly-target advertisements for additional or replacement products in such email order notifications. Moreover, the advertisements are presented to the customer at a time when customer may be more likely to purchase additional or replacement products.

While the invention described can be used as a stand alone system, it can also be used in combination with each of the features described in the co-pending Provisional Patent Application No. 61/023,138, assigned to the assignee of the present invention, and entitled “Email Advertisement System And Method” by Robert Mancarella and Rick Blaisdell, filed on Jan. 24, 2008, incorporated by reference herein. Such a combined system allows an organization to customize targeted electronic advertisement campaigns from multiple touch points within the organization.

Other features and aspects of the invention may be apparent to those skilled in the art upon reviewing the following drawings and description thereof.

### BRIEF DESCRIPTION OF THE DRAWINGS

FIG. 1 illustrates a typical outgoing email order confirmation prepared by an online retail system.

FIG. 1B illustrates an enhanced email order confirmation having an electronic banner and electronic advertisements framing the text of the order confirmation of FIG. 1A as would be viewed by a customer after opening the email order confirmation, created in accordance with the preferred embodiment of the invention.

FIG. 2 is a diagram illustrating a typical physical setup and operation of the invention.

FIG. 3 shows a screen in accordance with the preferred embodiment of the invention for importing electronic advertisement images from a website for an online retail store.

FIG. 4 is an example of a spreadsheet including information for importing electronic advertisement images.

FIG. 5 shows a screen for designing an advertisement campaign in accordance with the preferred embodiment of the invention.

FIG. 6 is a screen in accordance with a preferred embodiment of the invention illustrating the setup parameters for a software filter to search for product identification codes (e.g., SKU numbers) in an outgoing email order notification from an online retail system such as an order confirmation or an order cancellation notice.

FIG. 7 is a screen in accordance with a preferred embodiment of the invention listing various available product identification filters.

FIG. 8 is a screen for initiating a process to develop a statistical correlation between product identification codes (e.g., SKU numbers) in outgoing order confirmations in accordance with the preferred embodiment of the invention.

FIG. 9 is a screen for generating a report of email order confirmation notices subsequently sent to customers upon selection of an electronic advertisement placed in an enhanced outgoing email order notification in accordance with a preferred embodiment of the invention.

### DETAILED DESCRIPTION OF THE DRAWINGS

The drawings illustrate a preferred embodiment of implementing the invention.

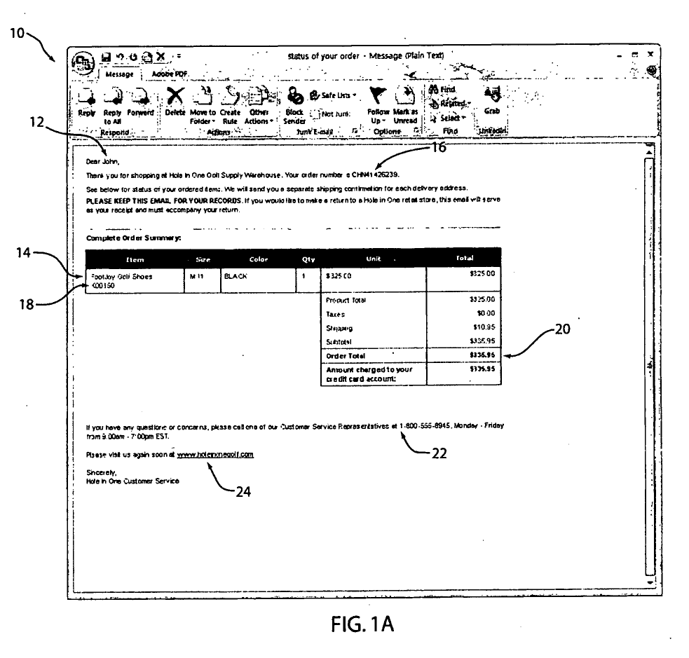

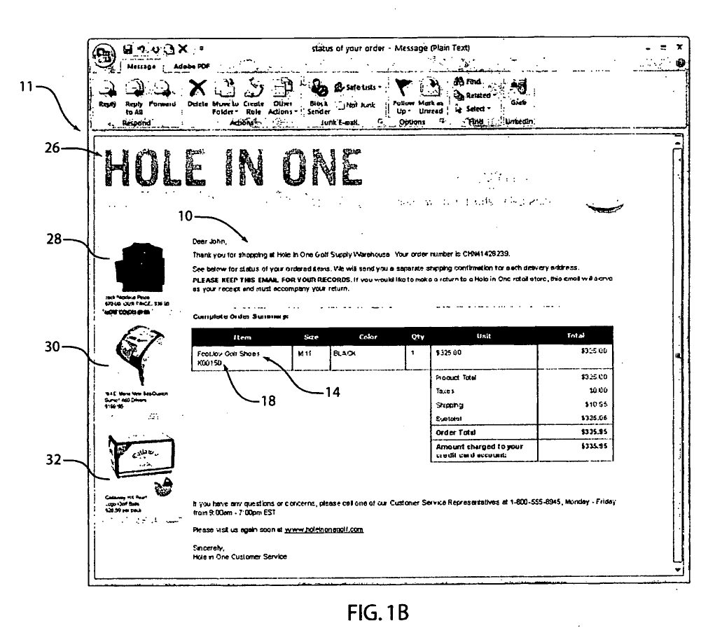

FIG. 1A illustrates a typical email order confirmation 10 generated by an online retail system. An email order confirmation 10, such as shown in FIG. 1A, would typically be created by an online retail system once the customer has checked out from the shopping cart software. The order confirmation 10 is emailed to the customer 12, in this case named John in order to confirm that the customer 12 has purchased a product 14 from its online retail store. The order confirmation 10 includes an order confirmation number 16. The product 14 purchased in this example is golf shoes, size men's 11, color black. The product 14 is identified by a product identification code 16 which, in this case, is a SKU number “K00150”. The email order confirmation 10 in FIG. 1A indicates that a separate shipping confirmation will be sent to the customer. The email order confirmation 10 indicates that the total amount 20 of the order, which includes the total for the product 14 as well as taxes and shipping, will be charged to the credit card account shown (as processed by the shopping cart software). The email order confirmation 10 also includes contact information 22 for a customer service representative, as well as a hyperlink 24 to the company website, all as is typical in the field of online retail shopping. The body of the email order confirmation 10 may include plain text and/or HTML text, which as mentioned, would typically be written automatically by an online retail system.

FIG. 1B illustrates an enhanced email order confirmation 11. The enhanced email order confirmation 11 the same email order confirmation 10 as shown in FIG. 1A after it has been enhanced in accordance with the invention, delivered to the intended recipient, and opened for reading. In accordance with the invention, the original text of the order confirmation 10 is framed by an electronic banner 26, and electronic advertisements 28, 30 and 32. Although not shown in FIG. 1B, it would also be typical to include an electronic footer. The specific physical layout of the banner 26, the footer and the advertisements 28, 30 and 32 is not critical to the invention; however, for each particular application of the invention, these dimensions will preferably be standardized.

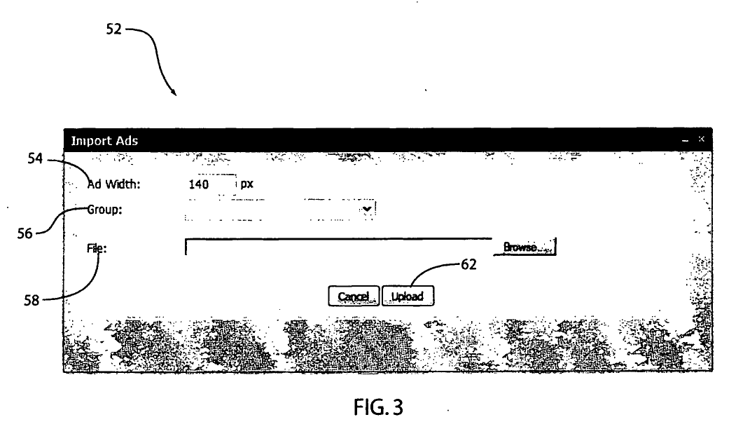

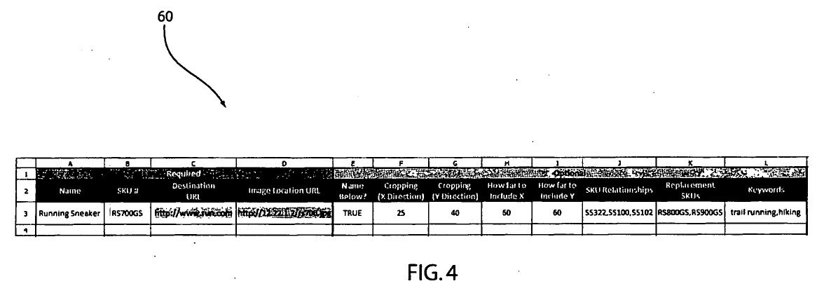

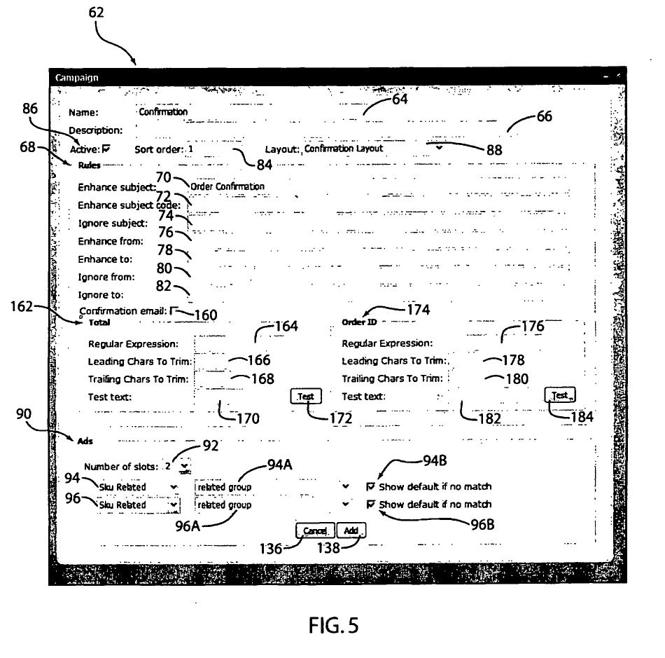

The electronic advertisements 28, 30, 32 are inserted into the enhanced email order confirmation 11, preferably according to campaign rules discussed below with respect to FIGS. 5-8. The content of the electronic advertisements 28, 30, 32 as well as their creation and inclusion into the system are discussed primarily with respect to FIGS. 3 and 4. Briefly, the electronic advertisements 28, 30, 32 are selected in accordance with criteria based on identification codes, preferably SKU numbers, assigned to products sold through the online retail system. The advertisements 28, 30, 32 are also associated with a URL link (or associated with a landing page), as described in incorporated U.S. Provisional Patent Application No. 61/023,138, entitled “Email Advertisement System and Method.” The customer is redirected to the destination website when the customer selects or “clicks on” a particular advertisement 28, 30, 32 framing the enhanced email order confirmation 11. As mentioned, the system preferably searches for identification codes (e.g., SKU number 18) assigned to the product 14 in the outgoing email message 10, preferably using a software filter that searches for a regular expression. The system includes data files for related SKU numbers or replacement SKU numbers, see e.g. FIG. 4, for each product sold on the online retail store. In the case of an outgoing enhanced email order confirmation 11, it is preferred that the advertisements 28, 30, 32 be for related products, preferably those that are statistically sold most frequently with or shortly after a customer purchases a particular product 14. If no statistically related products exist, then it is preferred to place advertisements on a rotating basis from a group of stored electronic advertisements. In the case of an email order cancellation notice (not shown), the placed electronic advertisements would preferably be directed to suggested replacement products. If no replacement products exist, then it is preferred to place advertisements on a rotating basis from a group of stored electronic advertisements.

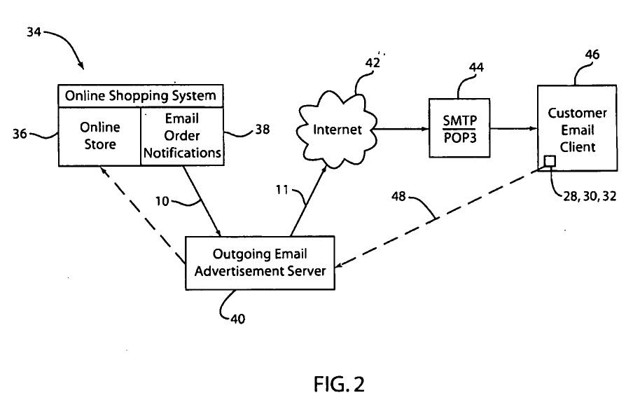

FIG. 2 is a schematic drawing illustrating the overall physical setup and operation of the invention. In FIG. 2, an organization's online shopping system 34 provides an online store 36 for its customers at a destination URL, and also has a system 38 for automatically generates email order notifications 10. The outgoing email notifications 10 sent from the online shopping system 34 are sent to an outgoing email advertisement server 40 which is configured in accordance with the invention. The preferred server appliance is a Supermicro™ computer appliance from Intel with 3 GHz processing speed, an 80 GB storage capacity and a one GB RAM, with a Linux OS operating system. The outgoing email advertisement server 40 is programmed preferably using the JAVA programming language, although other programming languages may be suitable. The server 40 stores electronic advertisements, banners and footers, as well as the logic for advertising campaigns, and also contains tracking and reporting software, as described in incorporated, co-pending U.S. Provisional Patent Application No. 61/023,138 entitled “Email Advertisement System and Method.”

In the preferred embodiment of the invention, an organization administrator or marketing manager accesses the software online using a web browser to configure the software for the particular organization. Electronic advertisement image files for the online store 36 are uploaded to the outgoing email advertisement server 40 as part of the configuration process, as explained with respect to FIGS. 3 and 4, and stored on the server 40 in order for later insertion into the outgoing email order notifications 11. Once the banners, footers and advertisements have been inserted, the outgoing email advertisement server 40 transmits an enhanced email order notification 11 over the internet 42 to the customer. The enhanced email order notification 11 is received in FIG. 2 by an SMTP/POP3 server 44 providing internet service to the customer. The customer's email client 46 communicates with the SMTP/POP3 server 44 to download the enhanced email order notification 11. When the customer opens the enhanced email order notification 11 with email client software, e.g. Microsoft Outlook™, the customer views the email order notification 11 framed with a banner, footer and/or electronic advertisements 28, 30, 32. Dashed lines 48, 50 show that the customer pings off of the outgoing email advertisement server 40 when the customer selects or “clicks on” an electronic advertisement 28, 30, 32 with a cursor, and is then directed to the online store 36 for the organization's online retail system 34. The outgoing email advertisement server 40 in this manner is able to track all placed advertisements 28, 30, 32, as well as all converted electronic advertisements. Also note that all outgoing email order notifications 38 from the online shopping system 34 pass through the outgoing email advertisement server 40. The server is thus able to track when a customer 46 selects an electronic advertisement 28, 30, 32, is directed to the online store 36 through the server 40, and subsequently consummates a follow-up purchase resulting in another email order confirmation being sent to the customer.

While FIG. 2 illustrates a situation in which the outgoing email advertisement server 40 appears to be dedicated to the organization's online retail system, it is contemplated that the outgoing email server 40 may also service the organization in accordance with the methods disclosed in incorporated, co-pending U.S. Provisional Patent Application 61/023,138 entitled “Email Advertisement System And Method.” As discussed in the incorporated patent, advertising campaigns are selected by comparing email header information to a set of programmed rules, preferably for the following categories: enhanced subject, enhanced subject code, ignore subject, enhance from, enhance to, ignore from, and ignore to. Thus, depending on the email header information, the organization can provide different types of advertising campaigns to its customers or potential customers receiving email from the organization. For example, email messages sent from a service department may be programmed to attach images of the product being serviced as detected from a text or word search of the email (or even a SKU number search), as well as to attach other types of documentation, for example, instructions or warranty information. Thus, the server 40 can be programmed in stand alone mode where it services only an online shopping system 34, or it can be part of a larger system serving part or all of an organization's outgoing email.

The email order notification 10 sent from the online shopping system 34 to the outgoing email advertisement server 40 would normally be prepared in MIME format. Hardware and software techniques for receiving email are well known in the art. While the MIME format is the most common email format, it may be desirable to enable the system to accept other email formats. A file in MIME format normally includes header information followed by text, images and HTML data. Once received and authenticated, the software on the server 40 checks the email header information to determine whether there is a campaign match. For example, if the subject field includes the words “order confirmation” or a subject code is entered in the subject field corresponding to an order confirmation, the outgoing email advertisement server will use a campaign programmed for outgoing email order confirmations. On the other hand, if the email order notification is an order cancellation, the server 40 will apply a different campaign for an email cancellation notice. Once the appropriate advertising campaign has been selected, the software creates the enhanced outgoing email order notification 11 preferably in the MIME format. The enhanced outgoing email order notification 11 is then transmitted to the customer over the internet, as discussed above. Beyond the selection of the inserted electronic banner, footers and advertisements, the technical creation of the MIME formatted, enhanced outgoing email order notification 11 uses techniques generally known in the art. The enhanced outgoing email order notification 11 preferably includes header information, followed by enhanced email in HTML format, the email message in plain text, attached images and inline images in order to make it highly likely that the customer's email client will recognize the plain text as well as the inserted electronic images and HTML data. Inlining the image means that the web address for the inserted advertisements will appear as a link at the bottom of the email order notification 11 in the event that the email client does not recognize HTML.

Referring to FIGS. 3 and 4, the system 10 preferably provides the ability to import electronic advertisement images automatically from an online store website 36 to the outgoing email advertisement server 40. FIG. 3 shows a screen in the system software entitled “Import Ads”. The “Import Ads” setup screen 52 includes prompts 54, 56 and 58 for the administrator to enter information to configure the server 40 to automatically import electronic advertisement images from an online store 36. Prompt 54 entitled “ad width” prompts the user to enter the width in pixels for advertisements in the outgoing email advertisements 11, e.g. advertisements 28, 30, 32 in FIG. 1B. The prompt 56 entitled “group” provides a field for the administrator to enter in a name for the group of ads that will be imported. For example, a single group of electronic images stored on the outgoing email advertisement server 40 may be stored for an online store 36, or several groups may be stored, such as a winter season group or a summer season group, or any other type of group. The prompt 58 entitled “file” provides for the entry of a file name for a data file including image importing information. Such a file preferably contains comma-separated values (CSV) in such a format that could be automatically generated by some online shopping systems or prepared by common spreadsheet applications.

FIG. 4 shows an example spreadsheet 60 for preparing the CSV import file. Column A in the spreadsheet 60 provides a field for entering the name of the product. It is contemplated that the spreadsheet 60 would include a row for each product that is sold on the organization's online store 36. Column B provides a field to enter the SKU number for this particular product. Note that the name of the product in column A may be a general name for the product, whereas the SKU number would normally be particular to the specific product being sold, its specific size and characteristics and/or its warehouse location. For example, as mentioned, the SKU number may be unique as to the color and size of a running shoe, as well as the warehouse in which the inventory is kept. Column C provides a field for the destination URL, which is the location that the customer will be redirected upon selecting or clicking on the electronic advertisement in the email order notification 11 corresponding to the product listed in column A and the SKU number in column B. Column D in spreadsheet 60 provides a field to enter the image location URL for the electronic image corresponding to the listed product and SKU number. The electronic advertisement image that is used for the online store 36 would typically be located in the URL location listed in column D. Columns A-D in spreadsheet 60 are required fields, which are necessary in order for the system to automatically upload the electronic advertisement images from the locations listed in column D to the outgoing email server 40. The upload button 62 instructs the system to automatically upload each electronic advertisement image from the location in column D in FIG. 4 to the outgoing email server 40Columns E-L in spreadsheet 60 corresponds to fields which need not be completed in order to upload the electronic advertisement images. Column E asks the administrator whether the name listed in column A should be placed below the advertisement image when the advertisement image is placed in the enhanced email notification 11. Columns F and G, respectively, prompt the administrator to enter the X and Y cropping directions. These directions are preferably measured in the number of pixels, from the upper left hand corner of the image located at the location identified in column D. Typically, all of the images for an online store will have uniform sizes; however, the size and shape of the images may not be well suited for insertion as a thumbnail into the enhanced email order notification 11. For example, there may be a significant amount of white space surrounding the images of the products. In this case, one would probably wish to automatically crop much of the white space from the image before scaling the image to size for insertion into the enhanced email order notification 11. Columns H and I refer to cropping as well. Column H requests the distance in pixels in the X direction from the position listed in column F should be included in the image. Likewise, column I requests the distance in pixels in the Y direction from the position listed in column G should be included in the image. If no values are put in columns H and I, the system preferably includes the entire image over and down from the position indicated in columns F and G. Once the electronic image has been cropped, the system them automatically scales the image, preferably proportionally in the X and Y directions, so that the ad width is the same as the value entered in the import ads setup screen 52 of FIG. 3 opposite the prompt 54 entitled “ad width”.

The spreadsheet 60 in FIG. 4 also includes three more additional fields, columns J, K and L, which relate to the selection of electronic advertisements for placement in enhanced outgoing email notifications. Column J entitled “SKU Relationships” includes SKU numbers for products that the company wishes to run an electronic advertisement when an order confirmation for a product in column A having the SKU number in column B is sent to the customer. For example, Column J might be populated with SKU numbers for related products having excessive inventory. Normally, however, the values populating Column J will not be used once the system has been operational for several months and has determined the related products via statistical correlation. Column K entitled “Replacement SKUs” contains SKU numbers for replacement products for the product in column A with the SKU number in column B. The system will preferably place advertisements corresponding to the replacement SKU numbers in column K when an order cancellation notice is sent to the customer for the product in column A with the SKU number in column B. Column L in the spreadsheet 60 in FIG. 4 is entitled “Keywords” and it includes keywords assigned to the product in column A having the SKU number in column B. The keywords in column L are used for ad campaigns using the “mail keyword” strategy described in detail in co-pending incorporated U.S. Provisional Patent Application No. 61/023,138.

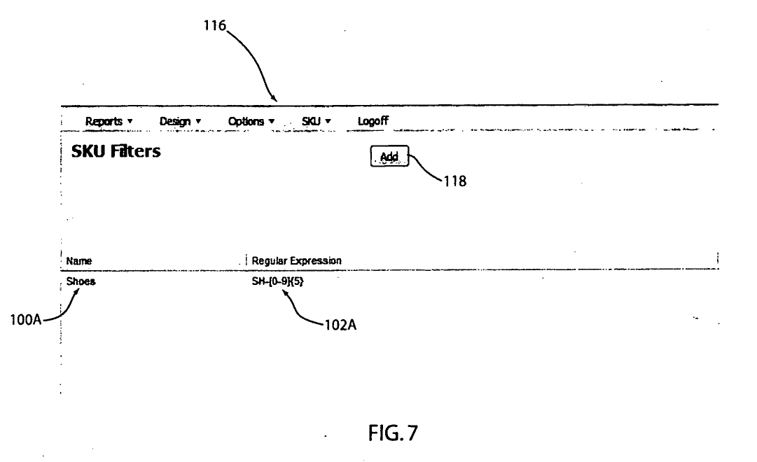

FIG. 5 illustrates the preferred campaign design screen 62 which is similar to that shown in FIG. 7 of the above-incorporated patent except that it is configured to enhance an email order confirmation 11 sent from an online retail store 36 with advertisements selected in accordance with the “SKU Related” technique described briefly above, and in more detail below. The name field 64 and the description field 66 are available for the administrator (or marketing manager) to name the particular advertising campaign and provide a description of the campaign. Campaign rules 68 are used to determine when this particular advertising campaign, i.e., the campaign named “Confirmation” in FIG. 5, shall be selected by the software. Under the advertising campaign selection rules 68, there are preferably seven fields, namely: “enhanced subject” 70, “enhanced subject code” 72, “ignore subject” 74, “enhance from” 76, “enhance to” 78, “ignore from” 80, and “ignore to” 82. The software is programmed so that the particular advertising campaign 64 applies only when there is a match for each and every field 70, 72, 74, 76, 78, 80 and 82, unless the field has been left blank. In FIG. 5, the “enhanced subject” field 70 has been filled with the words “Order Confirmation”. Therefore, the advertisement campaign named “Confirmation” will apply whenever an outgoing email notification from the online shopping system 34 includes the phrase “Order Confirmation” in the subject heading. In some cases, it may be desirable to use the “enhance from” field 76 or the “ignore from” field 80 to improve the reliability of the system in detecting actual order confirmations from the online shopping system which are sent along with all of the other outgoing email messages from the organization. In addition, the “enhanced subject code” field 72 can be used to identify order confirmations. The “enhanced subject code” field 72 is similar to the “enhance subject” field 70 except that the system will strip the code from the subject line in the outgoing email. For example, an “enhanced subject code” may be added to the original email order notification by the online shopping system such as “ord_confirm_fall_season”. Such a code could be used to force a particular advertisement campaign, yet the code would be stripped from the subject line in the outgoing enhanced email notification 11.

The prompt 84 labeled “sort order” allows the administrator (or marketing manager) to enter a priority for testing among the various advertising campaigns. In the preferred embodiment, a sort order of 0 puts a particular advertising campaign at the top of the queue; a sort of 1 would be below 0 but before 2. The prompt 86 entitled “active” enables the administrator to choose whether a particular advertising campaign should be considered within the queue. In other words, advertising campaigns can be stored on the server 40 but be designated as inactive. The layout field 88 in FIG. 5 allows the administrator to choose a specific framing layout for the advertising campaign. The design of various layouts is discussed in the above-incorporated co-pending provisional patent application entitled “Email Advertisement System and Method” having Application No. 61/023,138.

Still referring to FIG. 5, box 90 contains the strategy associated with a particular advertising campaign 64 for selecting electronic advertisements for insertion into the enhanced outgoing email order confirmations 11. First, the administrator is allowed to select the number of electronic advertising slots, as indicated by field 92 entitled “number of slots”. In FIG. 5, two slots have been chosen. For the example enhanced email order confirmation 11 shown in FIG. 1B, the number of slots chosen would have been three, one each before the electronic advertisements 28, 30 and 32. As discussed in the prior incorporated patent application, the maximum number of slots is five in the preferred embodiment. The strategy for selecting electronic advertisements to be inserted into the respective advertising slots can vary as also discussed in the prior incorporated patent application. However, in accordance with the present invention, when adding electronic advertisements to an email order confirmation, the “SKU Related” strategy is preferably used, as indicated in the first slot 94 and second slot 96 for the particular campaign in FIG. 5. When the SKU related strategy is selected, the system software searches the content of the outgoing email confirmation notifications for SKU numbers assigned to the electronic advertisements in the selected group 94A, 96A of advertisements. The selected group of advertisements 94A, 96A in FIG. 5 is named the “related group”. The screen 62 in FIG. 5 also shows a default prompt 94B, 96B for the SKU related strategies for the first slot 94 and the second slot 96. If the default prompt 94B, 96B is chosen, the software will automatically place an advertisement from the group 94A, 96A on a rotating basis in the event that there is no SKU number match. The software will not place duplicate advertisements. Also, the software can be programmed so that it will not place an advertisement for another product having a SKU number appearing in the order confirmation 10.

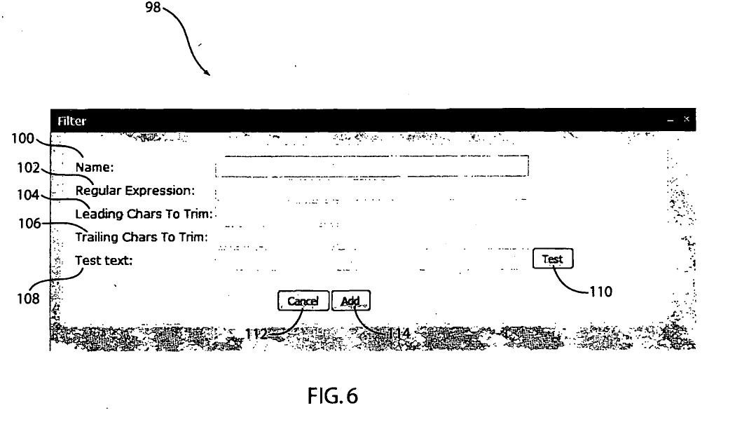

FIGS. 6-8 relate to the setup for the statistical correlation process preferably used in connection with the “SKU related” strategy. FIG. 6 shows a filter setup screen 98 which the administrator (or marketing manager) uses to define regular expressions for product identification codes or SKU numbers for each product sold on the online retail store 36. In the filter setup screen, prompt 100 provides a field for the administrator to enter a name for the filter. The prompt “regular expression” 102 provides a field for the administrator to enter a regular expression defining the characters for which the software identifies as a relevant identification code or SKU number. Prompts 102 and 104 allow the administrator to insert leading characters and trailing characters to trim. The trim leading characters field or trim trailing characters field 104, 106 in FIG. 6 can be used to trim characters such as item numbers that sometimes are located before or after SKU numbers. This may be useful when, e.g., the form of the part numbers, identification code or SKU numbers in not particularly unique compared to normal text. In that case, the system could be programmed to search for a term that precedes the identification code, e.g., “Item No.”, and identify subsequent characters as the identification code used by the software. Prompt 108 provides a field in which the administrator can enter a test SKU number to determine whether the regular expression entered in the field for prompt 102 is written properly. The administrator actuates button 110 to run the test. The cancel button 112 at the bottom of the screen is for cancelling the operation, whereas the add button 114 adds the filter to the list of available SKU filters, as shown in FIG. 7. Referring to FIG. 7, the SKU filters screen 116 lists each of the filters 100A and regular expression for each respective filter 102A available for use with a group of ads. The add button 118 is used to bring up the screen 98 in FIG. 6 to add another SKU filter to the list.

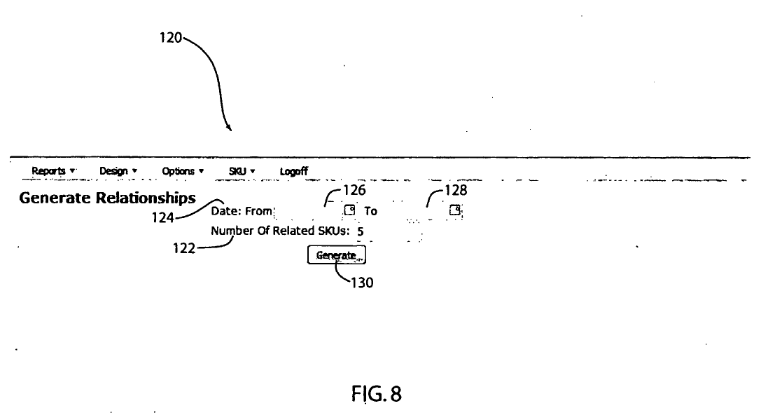

FIG. 8 shows a screen 120 which is used to generate the relationships between each of the SKU numbers in the group 94A, 96A of products sold on the online store. The prompt 122 labeled “number of related SKUs” provides a field in which the administrator can enter the maximum number of SKU numbers associated with a particular advertisement. The date prompt 124 provides a “from” field 126 and a “to” field 128. When the administrator activates the generate button 130, the software correlates the SKU relationships for past order confirmations between the dates entered in the “from” field 126 and the “to” field 128. If these fields are left blank, the software preferably will generate relationships from the beginning of system startup if the “from” field is left blank to the present time if the “to” field is left blank.

When the software on the server generates the SKU relationships, it analyzes all of the past email order confirmations that have passed through the server 40 for between the entered dates. Preferably, the server 40 correlates SKU numbers representing products sold together in the same shopping cart event. In this manner, the software determines which products are most frequently sold together over the given time period. The system uses this information in order to place the advertisements e.g. 28, 30, 32 in FIG. 1B when using the SKU related strategy 94, 96 in FIG. 5. For example, if only one product appears in the email order confirmation 10, the system will place electronic advertisements for the two most frequently correlated products, namely the most frequent for the first slot 94 and the second most frequent for the second slot 96. If two products appear in the email order confirmation 10, the system would still place the two most frequently correlated products, although one might be correlated to one product and the other to the other product or both correlated to the same product.

While other statistical correlations of the relationship between independent SKU numbers appearing in past outgoing email confirmations may be used in accordance with the invention, it is preferred that the system analyze SKU numbers for products sold in common shopping carts in order to have the statistically higher chance of consummating an immediate follow-up sale. Alternatively, for example, the SKU relationships may be developed by considering not only when SKU numbers are sold together in the same shopping cart but also to the same user over a defined period of time.

Referring again to FIG. 5, the campaign screen 62 includes a check box 160 labeled “confirmation email” that is checked by the administrator to indicate that the campaign is an order confirmation email. If the confirmation email box 160 is checked, the system will search the outgoing order confirmation and parse out the total value and the order identification number. The total box 162 includes a field 164 for entering a regular expression, a field 166 for entering leading characters to be trimmed, a field 168 for entering trailing characters to be trimmed, and a field 170 for entering text to test the regular expression entered in field 164 all for identifying the amount total (20 FIG. 1A) on the outgoing order confirmation 10. The order box 162 also includes a test button 172. The parsing operation and setup of the regular expression for identifying the total amounts in the order confirmations is similar to that for identifying SKU numbers in general. The order ID box 174 contains a field 176 for entering a regular expression, field 178 for entering leading characters to be trimmed, field 180 for entering trailing characters to be trimmed, and field 182 for entering text in order to test the regular expression in box 176. The order ID box 174 also includes a test button 184, again in order to test the regular expression entered in box 176. The regular expression entered in box 176 is programmed in order to identify the order identification number (see reference number 16 in FIG. 1A) in the outgoing email order confirmation 10. As mentioned, if the confirmation email box 160 is checked, the system will parse each email order confirmation for the total amount 20, FIG. 1A, and the order identification number 16, FIG. 1A, and will log the total amount and the order identification number along with the date of the order confirmation email.

Still referring to FIG. 5, the administrator can cancel a programming operation using the cancel button 136 or can use the add button 138 to load a particular campaign on the server 40.

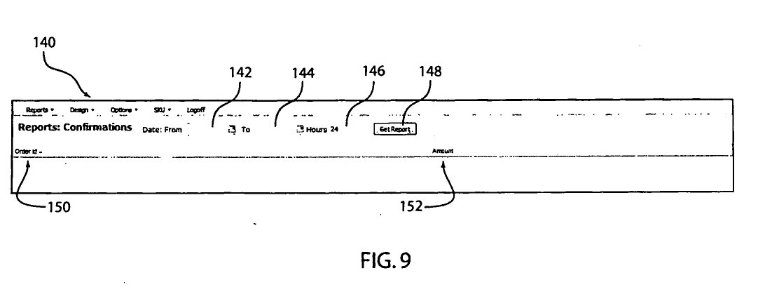

FIG. 9 shows a screen 140 that is used to generate a report of email order confirmation notices sent to various customers subsequent selection of an electronic advertisement placed in an outgoing email order notification (e.g. order confirmation, order cancellation or other notification). The screen 140 includes a “from” field 142 and a “to” field 140 for which the administrator enters the beginning and ending dates for the requested report. In the “hours” field 146, the administrator enters the number of hours which an outgoing order confirmation must be sent to the customer after the customer selects an electronic advertisement in an enhanced outgoing email message 11, FIG. 1B, and is redirected back to the online store 36. If an outgoing order confirmation is sent to the customer within the allotted time, the order is included in the report. The report, as indicated in FIG. 9, includes the order identification number 150, the amount of the order 152 as well as the date of the order (not shown in FIG. 9).

For a campaign that is related to order cancellation notices, in contrast to order confirmation notices, it is preferred to use a “SKU replacement” strategy in lieu of a SKU related strategy. For SKU replacement strategies, the replacement SKU numbers are imported into the system as described in connection with FIG. 4 and in particular column K. For the SKU replacement strategy, the system will search the email order cancellation notice for the canceled SKU number, and will then place an advertisement for one or more replacement products according to the replacement SKU numbers, as described in FIG. 4 for the canceled product. Otherwise, the system is preferably similar to that described above with respect to email order confirmations.

It is also desirable for the server to import SKU numbers for products that are out of inventory from time-to-time. In this case, the system will not place an advertisement 28, 30 or 32 in an enhanced outgoing email notification, whether it be an order confirmation or an email cancellation notice, if the specific product is out of inventory. If desirable, the system may place an advertisement corresponding to a replacement SKU number for the product having the SKU number which is out of inventory. Also, in some cases, it may be desirable to import SKU numbers for products for which there is excessive inventory, and use that information when setting priorities for selecting advertisements.

Note that while the preferred system shown is based on the use of SKU numbers, other types of unique product identification codes appearing in outgoing email order notifications may be used to facilitate use of the invention as well.

It should be appreciated by those skilled in the art that various aspects of the invention may be used separately and independently from other features of the invention disclosed.

We claim:

1. A method of selecting electronic advertisements for and inserting selected advertisements into outgoing email order confirmations, the method comprising the steps of:
providing a group of products for sale through an online retail system, where each product is assigned a unique identification code;
preparing an email order confirmation with the online retail system, wherein the order confirmation includes the unique identification code for each product purchased by the customer at checkout;
sending the email order confirmation from the online retail system after a customer has checked out;
receiving the email order confirmation by an outgoing email server;
storing at least one advertising campaign containing electronic advertisements on the outgoing email server for the group of products sold through the online retail system, wherein the electronic advertisement for each product is assigned the unique identification code for that product;
linking one or more identification codes for other products sold through the online retail system to the identification code for at least one product sold through the online retail system in the group;
searching the content of the email order confirmation for the assigned identification code for each product purchased by the customer at checkout;
selecting one or more stored electronic advertisements corresponding to products sold through the online retail system but not appearing in the email order confirmation, the selected one or more electronic advertisements having an identification code linked to the identification code assigned to the one or more products appearing in the email order confirmation;
creating an enhanced outgoing email order confirmation in which the original content of the email order confirmation is supplemented with the selected one or more electronic advertisements; and
sending the enhanced email order confirmation from the outgoing email server to the customer.

2. A method as recited in claim 1 wherein the unique identification codes are SKU numbers.

3. A method as recited in claim 1 wherein the step of linking one or more identification codes for other products sold through the online retail system is accomplished at least in part by statistically correlating the relationship of individual identification codes appearing in past outgoing email order confirmations.

4. A method as recited in claim 3 wherein the statistical correlation identifies one or more other products that are frequently sold in connection with the product assigned to a particular identification code appearing in the email order confirmation.

5. A method as recited in claim 4 wherein the statistical correlation relationship is generated for email order confirmations sent over a selected period of time.

6. A method as recited in claim 3 wherein the statistical correlation relationship is generated based only on the relationship of products appearing contemporaneously in past email order confirmations.

7. A method as recited in claim 3 wherein the statistical correlation relationship is generated at least in part by correlating the frequency of products appearing in email order confirmations sent to unique customers over a period of time.

8. A method as recited in claim 1 wherein the email order confirmation are searched for the identification codes using a software filter.

9. A method as recited in claim 8 wherein the software filter uses a regular expressions to identify identification codes in the outgoing email order confirmation.

10. A method as recited in claim 1 where, in the absence of an identification code for a product appearing in the outgoing email order confirmation for which another product and its identification code are linked, the enhanced email order confirmation is created by supplementing the content of the original email order confirmation with another one or more electronic advertisements for one or more products in the group.

11. A method as recited in claim 1 wherein storing at least one advertising campaign containing electronic advertisements for a group of products sold through the online retail system is accomplished at least in part by:
providing an import file including the identification code for all products in the group as well as a destination URL for an electronic advertisement for each product and an image location URL for the location an electronic image of the advertisements for each product;
automatically uploading each electronic advertisement image from the image location URL to the outgoing email server;
scaling the size of each uploaded electronic advertisement image to a size desired for placement in an enhanced outgoing email order confirmation; and
storing the scaled electronic advertisement images on the outgoing email server.

12. A method as recited in claim 11 further comprising the step of cropping each uploaded electronic advertisement image before scaling the uploaded electronic advertisement to a size desired for placement in an enhanced outgoing email order confirmation.

13. A method as recited in claim 11 wherein the import file contains comma separated values.

14. A method as recited in claim 1 wherein the step of selecting one or more electronic advertisements will not select an advertisement for a product for which the email server has been notified is out of inventory.

15. A method as recited in claim 14 in which the step of selecting one or more electronic advertisements selects an advertisement for a replacement product in the event that a product would have been selected but for being out of inventory.

16. A method of selecting electronic advertisements for and inserting selected advertisements into outgoing email order cancellation notices, the method comprising the steps of:
providing a group of products for sale through an online retail system, wherein each product is assigned a unique identification code;
matching one or more identification codes for replacement products sold through the online retail system with the assigned identification code for one or more of the products;
preparing an email order cancellation notice with the online retail system, wherein the cancellation notice includes the identification code for each product for which an order has been canceled;
sending the email order cancellation notice from the online retail system;
receiving the email order cancellation notice by an outgoing email server;
storing at least one advertising campaign containing electronic advertisements for products sold through the online retail system on the outgoing email servers, wherein the electronic advertisement for each product is assigned the unique identification code for that product;
searching the content of the email order cancellation notice for the identification code for each products for which an order has been canceled;
for each canceled product, selecting one or more electronic advertisements for the replacement products having identification codes matched to the identification codes assigned to the canceled product;
creating an enhanced outgoing email message in which the original content of the email order cancellation notice is supplemented with the selected one or more electronic advertisements; and
sending the enhanced outgoing cancellation notice from the outgoing email server to the customer.

17. A method as recited in claim 16 wherein the unique identification codes are SKU numbers.

18. A method as recited in claim 16 wherein the email cancellation notice is searched for identification codes using a software filter.

19. A method as recited in claim 18 wherein the software filter uses a regular expression to identify identification codes in the outgoing email cancellation notification.

20. A method as recited in claim 1 wherein the step of selecting one or more electronic advertisements will not select an advertisement for a product for which the email server has been notified is out of inventory.
